(19) United States
(12) Patent Application Publication
(10) Pub. No.: US 2024/0394724 A1
(43) Pub. Date: Nov. 28, 2024

(54) AUTOMOTIVE INDUSTRY REGULATIONS DASHBOARD

(71) Applicant: COMPAGNIE GENERALE DES ETABLISSEMENTS MICHELIN, Clermont-Ferrand (FR)

(72) Inventor: John EMERSON, Simpsonville, SC (US)

(21) Appl. No.: 18/777,789

(22) Filed: Jul. 19, 2024

Related U.S. Application Data
(60) Provisional application No. 63/504,446, filed on May 26, 2023.

(51) Int. Cl. G06Q 30/018; G06F 3/0482; G06F 3/0483; G06F 16/93; G06F 16/9538

(52) U.S. Cl. CPC G06Q 30/018; G06F 16/93; G06F 16/9538; G06F 3/0482; G06F 3/0483

(57) ABSTRACT

A system for searching highway transportation information is provided that has a user interface and a dashboard server with a search application configured for searching a plurality of tagged portions of documents. A website server is configured to generate a dashboard for viewing at the user interface. The website server is configured for receiving communication from the search application and returning searched tagged portions of documents to the user interface. A first one of the tagged portions of documents is a recall, and a second one of the tagged portions of documents is a final rule. In other embodiments, tagged full documents are used in place of, or in addition to, the tagged portions of documents.

### CROSS-REFERENCE TO RELATED APPLICATIONS

The present application claims priority and benefit to U.S. provisional patent application No. 63/504,446 filed on May 26, 2023 titled “Automotive Industry Regulations Dashboard.” U.S. provisional patent application No. 63/504,446 is incorporated by reference herein in its entirety for all purposes.

### FIELD OF THE INVENTION

The subject matter of the present invention relates to a dashboard that is used by the highway transportation industry to monitor and search technical service bulletins, investigations, recalls, or other activities associated with regulations, safety standards, and other requirements. More particularly, the present application involves a highway transportation industry dashboard that consolidates automotive regulation information into one tool for the user that can be searched, accessed and displayed in a unique user interface.

### BACKGROUND OF THE INVENTION

The National Highway Traffic Safety Administration (NHTSA) is a Federal agency of the United States department of transportation. The NHTSA issues Federal Motor Vehicle Safety Standards (FMVSS). These regulations are designed to improve safety and prevent or reduce vehicle crashes in the highway transportation sector. The manufacturers of motor vehicles and motor vehicle equipment, and those who import and put these items into commerce are required by law to comply with certain product requirements, make certain reports to NHTSA, execute market actions, and apply required product labels.

The regulations of the NHTSA involve multiple information sources and thousands of pages. These documents are distributed over various websites that each have their own way of presenting and searching these documents. The documents on one website cannot be linked to those of another, and using different documents from various websites cannot provide the researcher with an overall picture of the regulation landscape of a particular topic. There is no tool available for one to easily search, sort, filter, and summarize information pertinent to a particular manufacturer type to understand the regulations and requirements of that particular manufacturer type. A docket index of NHTSA content is currently not available, which may hinder searchers in trying to locate particular automotive regulation content.

The current searching schemes enable only one-dimensional searching that is only partially effective, and tagging of information is not used to return pertinent content. Since such a variety of formats of information is present, separate searching and time intensive labor is necessary to consolidate information found on various websites to form a comprehensive report. Current regulations searching may provide only lists of links to articles in newsletter format and cannot be customized or refined to deliver a desired report. Historical perspective of the regulations is not possible under current regulation searching. Although the segmented searching and document storage capability presently used can allow one to explore small portions of the available data, a comprehensive solution using a tagging system that allows users to find all relevant data with one tool is not known.

The Federal Register is the official journal of the federal government of the United States and is issued on a daily basis. One known way of monitoring some required highway transportation regulations is for one to read each day the issued Federal Register and pay attention to those articles or documents that are relevant to the highway transportation sector. This sort of monitoring is time intensive and may still result in some highway transportation regulation information being missed. Although ways of searching for and locating highway transportation regulations are known, there remains room for variation and improvement within the art.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a dashboard as displayed with the monthly trend tab selected.

FIG. 2 is the dashboard as displayed with the quarter trend tab selected.

FIG. 3 is the dashboard as displayed with the top 10 regulatory activities tab selected.

FIG. 4 is the dashboard of FIG. 3 but further filtered by selecting one of the “make” criteria.

FIG. 5 is the dashboard display upon selection of the article tab.

FIG. 6 is the dashboard display upon selection of the interpretations tab.

FIG. 7 is the dashboard as displayed with the IPs Receipt being selected as the only search criteria in selection.

FIG. 8 is a schematic view of a prior system for searching for and accessing automotive industry regulatory information.

FIG. 9 is a schematic view of a current system for searching for and accessing automotive industry regulatory information.

FIG. 10 is a detailed schematic view of the dashboard server in accordance with one exemplary embodiment.

FIG. 11 is a schematic view of a computing system that can be used to implement aspects of the present system.

The use of identical or similar reference numerals in different figures denotes identical or similar features.

### DETAILED DESCRIPTION OF THE INVENTION

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

The present invention provides for a system of generating a dashboard 10 that presents automotive regulation information in a format that is easy to search, view, and sort. The dashboard 10 provides the user with a single point source of regulation information for viewing activity by manufacturer, manufacturer type, regulation type, laws and reports. The dashboard 10 has a time interface that allows the user to view the number of regulatory activities in different time frames, and provides the user with the ability to view the entire document of interest. The system consolidates all of this information into one tool, and uses tags to organize and search the information of various sources. The system saves time and avoids blind spots that could otherwise be present if one were required to navigate to and search different sites to collect the necessary information.

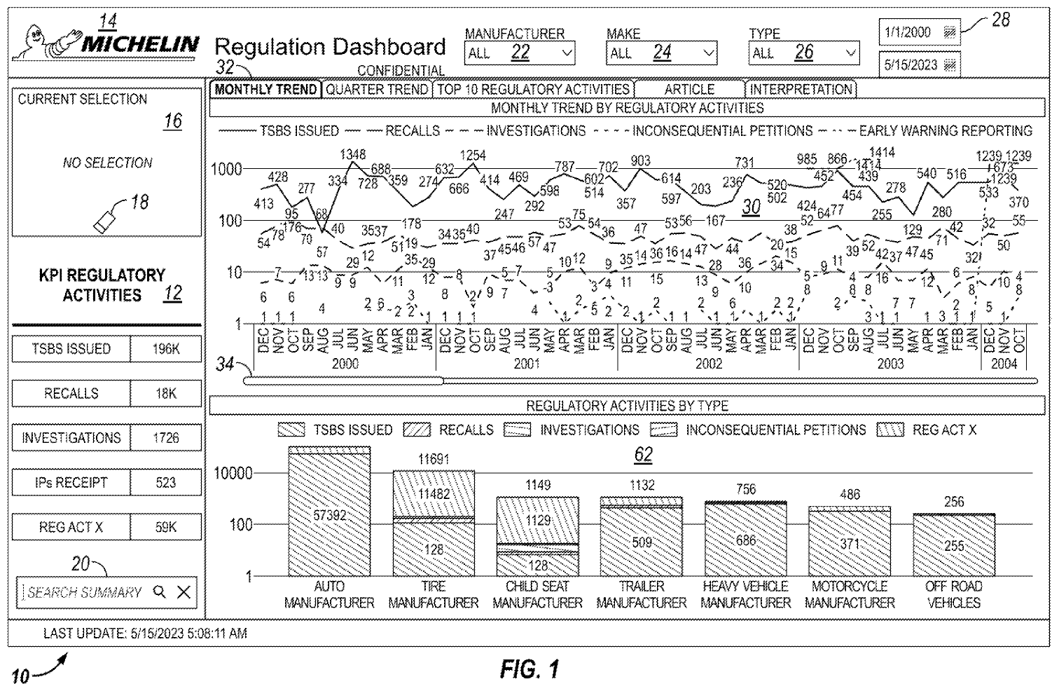

FIG. 1 is a display of the dashboard 10 for use in searching, sorting, viewing, and accessing automotive regulation information. A list of regulatory activities 12 are shown on the left hand side of the dashboard 10 and are searchable and sortable automotive regulatory matters. Each regulatory activity 12 is named, and the amount of each one of that type of regulatory activity 12 is provided as per the current search criteria selection of the dashboard 10. A current search selection window 16 is present just above the regulatory activities 12 that displays the currently selected search criteria. In FIG. 1, the current search selection window 16 shows that no search criteria has been selected, and because of this the dashboard 10 displays all of the regulatory activity 12 data. If search criteria had been selected, it could be cleared by selecting the search clear button 18 to revert back to the display of FIG. 1 in which no search criteria is selected.

The key performance indicators include five different types of regulatory activities 12. TSBS Issued are technical service bulletins that are documents issued by manufacturers and sent to service centers, mechanics, and dealerships to provide information on servicing the product. The issues reported by technical service bulletins address a range of issues, and customers could be charged by the service center for these repairs. Recalls are distinguished from the technical service bulletins (TSBSs) in that recalls are a communication from a manufacturer to repair or replace a product or have it returned for a refund due to a regulatory non-compliance or defect. Recalls result in a refund or a repair or replacement of the product.

Also included in the regulatory activity 12 section are investigations. These are inquires by NHTSA related to regulatory compliance, alleged or suspected safety defects, etc. Investigations can be initiated based on a variety of inputs or indicators. NHTSA will conduct a thorough assessment to determine if corrective action is required.

The Inconsequential Petitions (IPs) Receipts are regulatory activities 12 that are petitions for inconsequential noncompliance of manufacturers in which they submit a petition to NHTSA for a determination that a previously declared non-compliance is inconsequential to vehicle safety and therefore does not require a recall. In these instances, the manufacturer will identify the specific regulation or standard that is not met, and provide an explanation as to why such noncompliance is inconsequential to motor vehicle safety. These petitions could be allowed by NHTSA to excuse the manufacturer from the obligation to execute a recall, or denied based upon the particular facts of the matter.

The fifth regulatory activity 12 is shown and is identified as “Reg Act X” and can be any other type of regulatory activity 12 relevant to the user of the dashboard 10. In some embodiments, the fifth regulatory activity 12 is not present, and in others, additional regulatory activities 12 are present. As such, it is to be understood that any number of regulatory activities 12 can be present in the dashboard 10. There may be 2, 3, 4, 5, or 6 regulatory activities 12 in the dashboard 10 in accordance with certain exemplary embodiments. There may be from 7-10, from 11-15, or up to 20 regulatory activities 12 in accordance with various embodiments of the system.

Some additional examples of regulatory activities 12 that could be used in the dashboard include complaints. Complaints are communications that people or companies deliver to NHTSA or others in which they complain about the quality of the product or services. Another regulatory activity 12 that could be present in the dashboard 10 in other embodiments include EWRs. These are early warning reports that are provided by the manufacturers to comply with Federal regulation mandates. The EWRs could be, for example, the number of reportable claims submitted for a given time period. The reporting requirements for manufactures may be different depending on the size of the manufacturer and the product they are producing.

The regulatory activities 12 are all documents that can be viewed by the user if desired and are counted on the dashboard 10 as per the search criteria that is entered. The dashboard 10 also has a search refinement 20 that includes a text window into which the user can entered desired text for searching. This searching may be an initial search that includes all data of the regulatory activities 12, or can further limit the previously filtered regulatory activities 12. If a search term such as “seat belt” were entered into the search refinement 20, the dashboard 10 will be further limited by reducing the displayed regulatory activities 12 to only those that include this search term.

The dashboard 10 includes a banner 14 that includes various search drop downs in order to filter the data in the dashboard 10. The first drop down 22 shown is a manufacturer drop down that can be selected to display only those regulatory activities 12 from a particular manufacturer or manufacturers such as Manufacturer A, Manufacturer B, Manufacturer C, or Manufacturer D. The second drop down 24 is a “make” drop down that can be selected to limit the displayed regulatory activities 12 to one or more makes of product such as Make A, Make B, Make C, or Make D. The Manufacturer is the name of the company that makes the product, and the Make is the name of the product itself made by the Manufacturer. One Manufacturer can produce multiple different Makes. The banner 14 also includes a third drop down 26 window entitled “type” which can be used to limit the displayed regulatory activities 12 to one or more different types of manufacturers. The selection options for type may be, for example, an auto manufacturer, a child seat manufacturer, a heavy vehicle manufacturer, a motorcycle manufacturer, off road vehicles, tire manufacturer, or trailer manufacturer. The displayed regulatory activities 12 can be selected by using the selection criteria from one, two, or all three of these drop down 22, 24, 26 windows in the banner 14. Once the selections are made, the dashboard 10 may be updated so that only those regulatory activities 12 that are within the selected search criteria are shown on the dashboard 10.

The banner 14 on the right hand side also includes a time selection 28 that can be used to further limit the regulatory activities 12 displayed on the dashboard 10. The time selection 28 shown in FIG. 1 is from Jan. 1, 2000 to May 15, 2023 such that all regulatory activities 12 available in that time frame is displayed. The time selection 28 has two options available to the user to make the desired selection. First, a pair of calendars can be opened up and navigated to select a particular start date and a particular end date for the data range. These calendars could also be manipulated such that the user simply types in the start and/or end date to make the desired selection. Second, the time selection 28 may have a slider bar (not shown in FIG. 1) that has two points on it that can be slid left or right to establish the desired date range for the regulatory activity 12 selection.

The dashboard 10 also has a graphical display 30 that displays the regulatory activities 12 that have been selected by the various selection criteria. In this regard, a legend showing the technical service bulletins (TSBS) issued, the recalls, the investigations, the inconsequential petitions (IPs) received, and the Regulatory Activity X (Reg Act X) is present to distinguish one from the other. The selected regulatory activities 12 are displayed on a line chart that is color coded such that each regulatory activity 12 has its own unique color. Alternatively or additionally, different line thickness or dashes can be used to further distinguish the different regulatory activities 12. The graphical display 30 includes dates on its x-axis and number of regulatory activities 12 on its y-axis such that a value on the graphical display 30 in the line chart is the number of regulatory activities 12 on that particular date. Since five regulatory activities 12 are selected, each date on the x-axis will yield five points, one for each one of the regulatory activities 12. If that particular regulatory activity 12 is not present on a particular date, its simply left off of the graphical display 30 instead of being marked as a “0” at the bottom of the y-axis. For each one of the regulatory activities 12, a line chart is constructed to link each value from date to date. The area of this line chart can be filled in based upon the color of the particular regulatory activity 12, or based upon the line thickness or other distinguishing characteristic in the legend or otherwise associated with that one regulatory activity 12. The line charts of each regulatory activity 12 are overlayed on top of one another such that all are displayed. Of course, if the selection criteria were made to result in only one or two of the regulatory activities 12 being chosen, then only those one or two would be presented in line chart form in the graphical display 30. The graphical display 30 includes the numerical number next to the point drawn in the chart so that the user can readily identify how many of the regulatory activities 12 were present on that particular month of that particular type. The y-axis is also scaled by a factor of 10 for each equal amount of distance on the y-axis. This scaling can be adjusted or eliminated based upon the particular values displayed in the selected time frame.

The graphical display 30 includes a timeline slide bar 34 beneath the line charts that can be pulled to the left or right by the user. Usually, the time selection is made so that a large date range is present, and in order to view the data in a meaningful way only a certain amount of that date range can be shown. The user can move the timeline slide bar 34 to the left or right to view other portions of the selected time range as desired. As such, it is to be understood that the graphical display 30 may not display all of the selected regulatory activity 12 data at the same time, but only a portion thereof. The rest of it can be displayed upon using the timeline slide bar 34 to view other portions of the selected date range on the x-axis.

The dashboard 10 includes a secondary display 62 in the FIG. 1 display that has no selection criteria. The secondary display 62 shows all seven of the types from the third drop down 26 in bar graphs. For each one of the types, the number of regulatory activities 12 are shown in that particular bar graph for that particular type. The numerical number is charted on the y-axis, and the numerical number is shown in or associated with the particular amount of the regulatory activity 12 in the bar graph. If the number of the regulatory activity 12 is small on the bar graph, its value may or may not be shown. The secondary display is a graphical display, and includes a legend of each one of the regulatory activities 12 in color or otherwise identified in the bar graphs for each individual type.

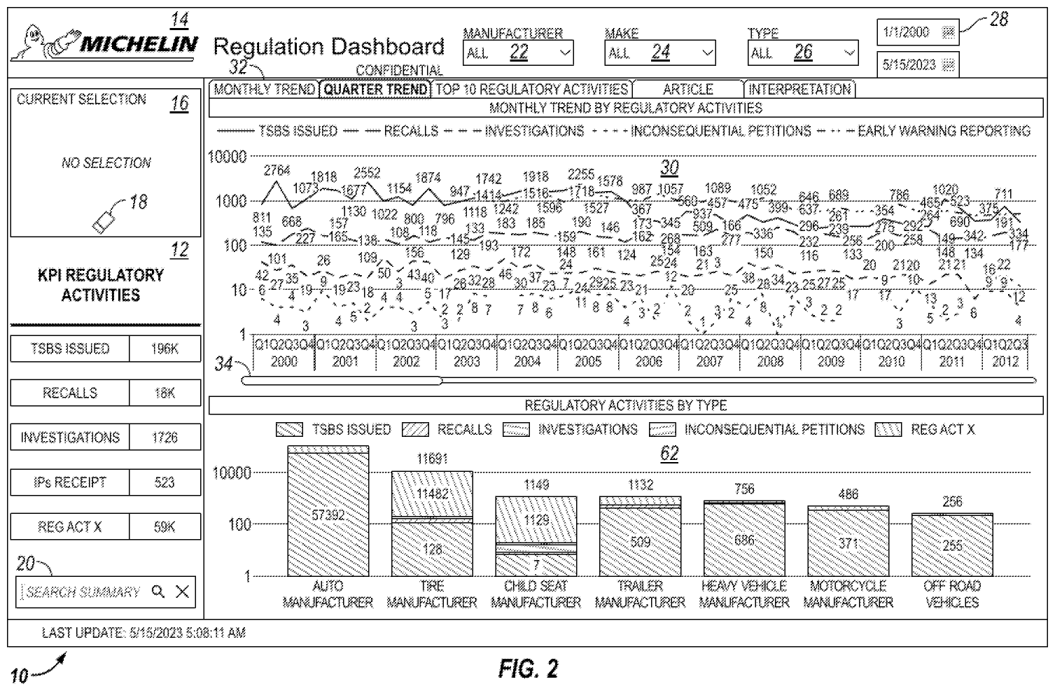

The dashboard 10 has five tabs 32 located above the graphical display 30 that can be selected to affect the graphical display 30. In this regard, the tabs 32 read “monthly trend”, “quarter trend”, “top 10 regulatory activities”, “article”, and “interpretation.” In FIG. 1, the monthly trend tab 32 is selected and the graphical display 30 in turn displays data for each particular month in the selected time frame. FIG. 2 shows the same dashboard 10 of FIG. 1, but with the “quarter trend” tab 32 selected instead of the “monthly trend” tab 32. If the user selects the “quarter trend” tab 32 then the graphical display 30 is adjusted from that of FIG. 1 to show quarters on the x-axis instead of each month. Adjustment to the quarter trend tab 32 causes the regulatory activity 12 data for each particular quarter to be displayed as a point with their value next to that point. A line chart is drawn moving from quarter to quarter based upon the values for the regulatory activity 12 in a similar manner as with the monthly trend tab 32 graphical display 30. The numbers are different because each quarter on the x-axis is data for the entire quarter instead of on a monthly basis. Since the x-axis is compressed to quarters from months, there is a larger spread of time on the x-axis and thus more years can be shown on the graphical display 30 from that shown when the monthly trend tab 32 is selected.

Moving the tab 32 to the quarter trend in FIG. 2 does not change the secondary display 62 from that as displayed in FIG. 1 in which the monthly trend tab 32 is selected. Selection of the tab 32 between the quarter trend and the monthly trend changes the graphical display 30, but does not affect anything in the secondary display 62 as it remains completely the same even though the graphical display 30 is changed.

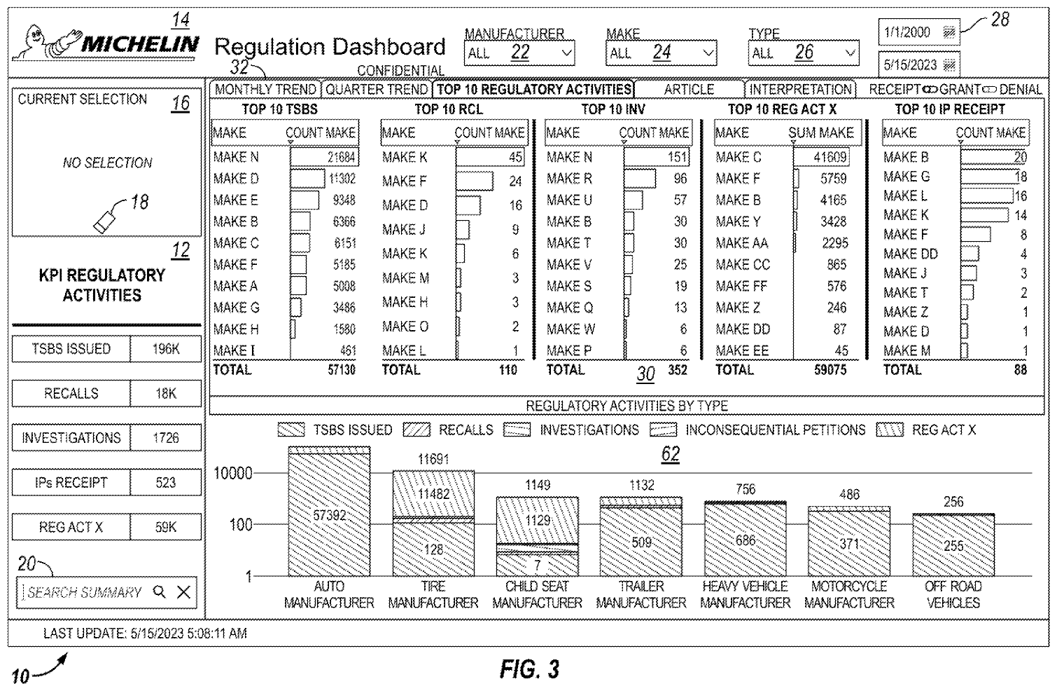

Selection of the “top 10 regulatory activities” tab 32 causes the graphical display 30 to be presented as that shown with reference to FIG. 3. The graphical display 30 in this instance does not include the timeline slide bar 34 and does not present a line chart with an x-axis and y-axis. Instead, each one of the regulatory activities 12 is displayed in the graphical display 30 and the top 10 “Make” is displayed along with the particular value in order from number 1 at the top of the list to number 10 at the bottom of the list. For example, as shown in FIG. 3, “Make N” is the make that has issued the most technical service bulletins (TSBS) at 21,684 and is listed first in the list for the “top 10 TSBS” and this value is displayed next to the name Make N along with a horizontal bar that is sized relative to the other 9 in the top 10 TSBS list to offer a visual indicator of disparity or closeness in value thereto. The total of the top 10 TSBS is tabulated at the bottom of the list which is the sum total of the 10 listed makes.

The other listed top ten regulatory activities in the graphical display 30 are the top 10 recalls, the top 10 investigations, the top 10 regulatory activity X (Reg Act X), and the top 10 inconsequential petitions receipts. These lists are likewise tabulated based upon the “Make” values and each top 10 list has the sum total at the bottom for the top 10 various makes. All of the top ten lists include the value of the “Make” along with a bar graph representing the value in comparison to the other 9 values in that particular top 10 list. The top 10 inconsequential petition receipt list has an additional selection item for the user. The default is “receipt grant” which can be instead deselected so that “receipt denial” is instead selected. FIG. 3 shows the top 10 inconsequential petition receipt with the “receipt grant” selected so that the makes in that list are the inconsequential petitions that have been granted by the NHTSA. If instead “receipt denial” is selected, the top 10 inconsequential petition receipt list would change so that those petitions that have been denied by the NHTSA are counted which will most likely change the make column, and will certainly change the values that are displayed. The secondary display 62 is the exact same as that of FIGS. 1 and 2 that include the same search criteria in the current search selection window 16 and does not change at all upon the selection of tabs 32 from the monthly trend tab to the quarter trend tab, to the top 10 regulatory activities tab.

The dashboard 10 includes various features that allow for further refinement of the data to decrease the amount of selection and searching the user must execute to get to the relevant data. For example, taking the dashboard as presented in FIG. 3, the user could click on the Make Z name in the “top 10 inv” list so that the top 10 regulatory activities 12 are further limited to this make. Doing so causes the current search selection window 16 to display the make as “Make Z” and causes in the listed display of the regulatory activities 12 to list only those that are associated with Make Z. In this regard, that particular make has only one TSBS report issued, no recalls, 6 investigations, one IPs received, and 246 Reg Act X. The graphical display 30 is likewise adjusted when this make selection is made in the “top 10 inv” list. Here, upon this selection, the “top 10 inv” list does not change, but the other 4 top 10 lists in the graphical display 30 are in fact changed so that only data related to Make Z are shown in each of these 4 top 10 lists, and so that all other make data is excluded from these 4 top 10 lists resulting in only one entry being present in each of the 4 remaining top 10 lists. This graphical display 30 option provides the user with enhanced visibility of the regulatory activity of this particular make.

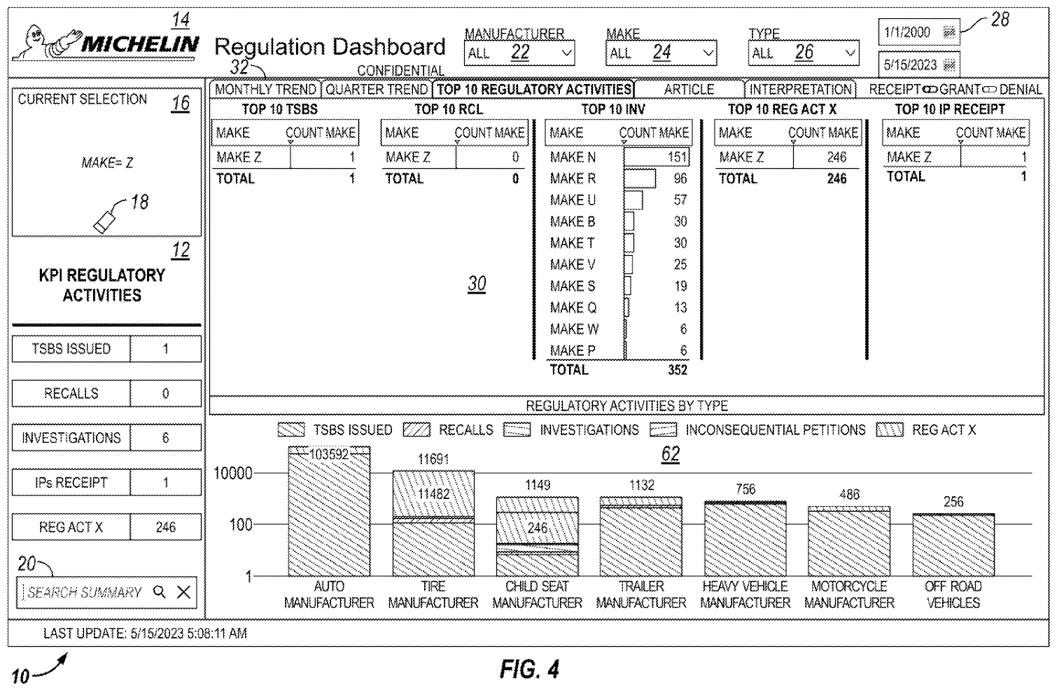

The secondary display 62 is changed in FIG. 4 from that shown in FIG. 3. In this regard, the bar chart that includes the child seat manufacturer type remains in the same colors and lighting as previously shown in FIGS. 1-3, but the other six bar charts have some of their number values removed and are of a lighter shade than as previously shown in FIGS. 1-3. The reason the child seat manufacturer bar graph is highlighted in view of the others is because the selected Make Z falls within the child seat manufacturer type.

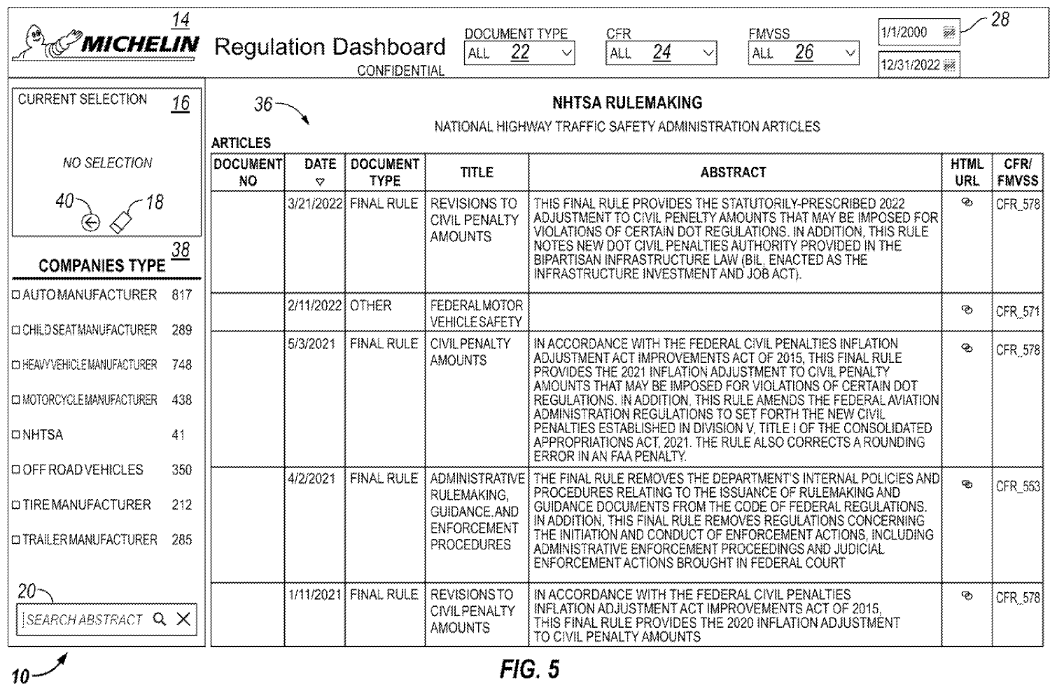

The tabs 32 include one labeled “article” and this tab is related to articles published by the National Highway Traffic Safety Administration which is a subagency of the Department of Transportation. These articles are desirable for someone responsible for complying with automotive regulations. Selection of the “article” tab 32 will cause the dashboard 10 to change to the display shown in FIG. 5 in which the graphical display 30 is removed from the dashboard 10. In its place, a chart display 36 that includes the articles of the National Highway Traffic Safety Administration is shown. The chart display 36 shows only those articles that have been selected by the user as per his or her selected search criteria. The first, second, and third drop downs 22, 24, 26 are modified from those previously discussed. The first drop down 22 allows for the selection of a document type which can limit the articles listed in the chart display 36 to only the type or types selected. The document types that can be selected in the first drop down 22 include advanced notice of proposed rulemaking, final rule, notice of proposed rulemaking, other, petition for reconsideration, proposed rule, public hearing, and request for comments.

The second drop down 24 allows the articles in the chart display 36 to be filtered based upon whether the article touches a particular code of Federal regulations (CFR). The code of Federal regulations is the codification of the general and permanent rules published in the Federal register by the departments and agencies of the Federal Government. The second drop down 24 allows the user to select one or more specific sections of the code of Federal regulations to which the articles in the chart display 36 will be limited. Examples of specific sections that can be selected in the second drop down 24 from title 49 that relates to transportation include 49 CFR § 501, § 509, § 510, § 511, § 573, § 574, § 575, § 595, and § 599. However, other sections from the CFR could be included as well in the second drop down 24 for limiting the articles provided in the chart display 36.

The third drop down 26 may even further limit the articles that are shown in the chart display 36. The Federal motor vehicle safety standards (FMVSS) are U.S. Federal vehicle regulations specifying performance, and labelling requirements for motor vehicles and regulated automobile safety-related components. Specific ones of these standards can be selected by the user in order to limit the articles shown in the chart display 36 to only those that include some discussion or interpretation of the selected FMVSS. Examples of specific ones of the FMVSS that can be selected in the third drop down 26 include FMVSS 255, 226, 301, 101, 102, 103, 104, 136, 138, and 139. Again, these are only examples of some FMVSS that can be included in the third drop down 26, and additional ones may be included for filtering the chart display 36 as desired.

The banner 14 also includes a time selection 28 for limiting the articles searched to a time frame if desired. The articles can also be filtered in the chart display 36 based upon company type 38 which are shown in a window on the left hand side of the dashboard 10 under the current search selection window 16. One or more of the listed company types 38 can be selected so that only articles from those particular types of automotive companies are displayed in the chart display 36. Next to the company types 38 is a number value which indicates how many articles of the current selection are in fact associated with that particular company type 38. The company types 38 that can be selected include auto manufacturer, child seat manufacturer, heavy vehicle manufacturer, motorcycle manufacturer, National Highway Traffic Safety Administration (NHTSA), off road vehicles, tire manufacturer, and trailer manufacturer. This list can be added to or modified in other exemplary embodiments. The dashboard 10 includes a search refinement 20 that is a text search in which text input into the search refinement will cause the abstracts of the articles to be searched, to which only those articles having the input text will be shown in the chart display 36. If the articles have been reduced through various refinements using the drop downs 22, 24, 26, the time selection 28, or company types 38, the search refinement 20 can further limit the articles displayed in the chart display 36 to only those having the desired search terms in their abstracts. Alternatively, if none of the search tools such as the drop downs 22, 24, 26, time selection 28 or company type 38 are used, the search refinement 20 can be used to do an initial search of the abstracts to initially limit the articles of the chart display 36, and if desired additional searching refinement can be performed.

The chart display 36 includes one row for each article, and various columns that include data or links for that particular article. The first column on the left hand side is the NHTSA docket number of the particular article. Currently, there is not a docket index available to search via NHTSA docket numbers, and the present dashboard 10 allows for the first time provides a link between the NHTSA docket numbers and the articles they reference. In this manner, one can sort or search for articles based upon the NHTSA docket number, and one can associate the NHTSA docket number with the other information in the row in FIG. 5. The chart display 36 includes a date column that provides the date of each article, and this data allows the articles to be filtered in the chart display 36 by the time selection 28. The chart display 36 includes a document type column that lists the article's document type, and allows for the articles to be selected based upon the first drop down 22 that is the document type selection. Another column in the chart display 36 is the title which is the title of the article. An abstract column is also included and is a column that displays the particular abstract of the article in question. This abstract can be searched by the search refinement 20 so that key words from the abstract are identified to give the user access to the relevant article in question. Also included in the chart display 36 is a column that provides the user with a link that can be clicked to open up a new window that is directed to a website that includes the article in question. For example, the first article in the chart display 36 includes a link to federalregister.gov of the article for Revisions to Civil Penalty Amounts that can be read by the user. The last column in the chart display 36 lists for each article the CFRs and/or FMVSSs that are implicated in that particular article. There may be any number of, or no, CFRs and/or FMVVSs in this column associated with the article in question. The second and third drop downs 24 and 26 may be used to filter the articles so that only those articles associated with desired CFR and/or FMVVS are displayed in the chart display 36.

The chart display 36 lacks graphics or a timeline slide bar 34 that are present with the graphical display 30. The chart display 36 can be scrolled downward in the vertical direction, with a scroll bar on the right hand side, so that the rest of the articles that are returned based upon the selected search criteria can be viewed and accessed. The amount of articles shown at any one time on the chart display 36 is limited by the amount of articles and the text size of the information that can be displayed. The chart display 36 is thus configured differently from that of the graphical display 30 in that a chart is presented rather than a graphical representation of number values of activities. When the article tab 32 is selected and the graphical display 30 replaced with the chart display 36, the secondary display 62 is not displayed on the dashboard 10.

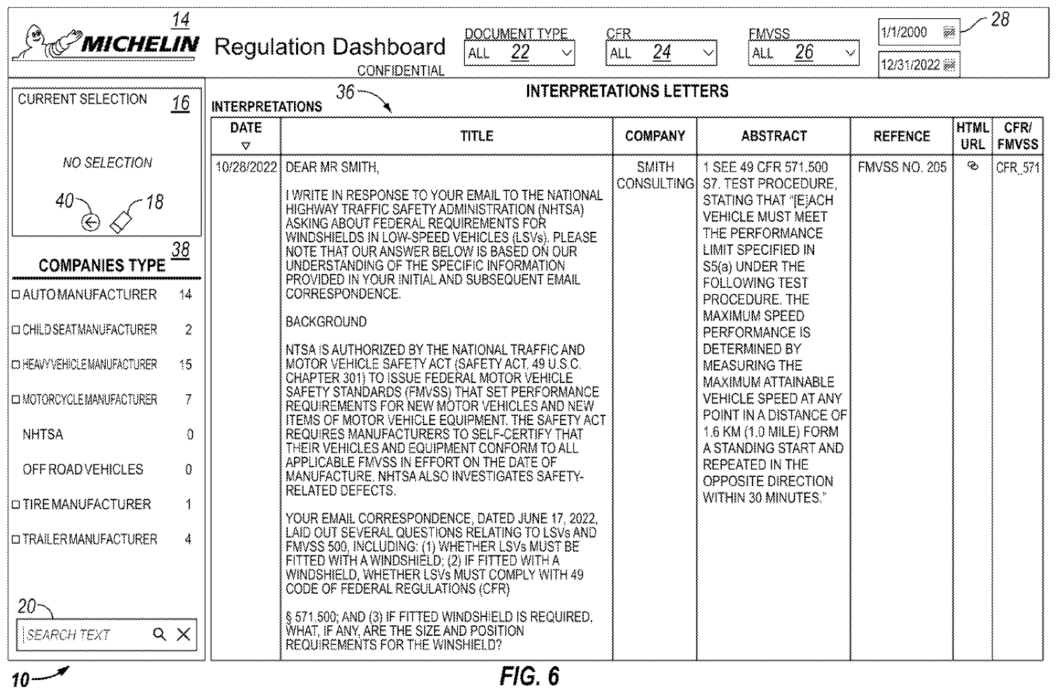

If the interpretation tab 32 were selected in place of the article, top 10 regulatory activity, quarter trend, or monthly trend tabs 32, the dashboard 10 will display as that shown in FIG. 6. Interpretation letters are issued in response to an inquiry from the industry about a particular standard or regulation. The interpretation letters look at the particular facts and law and offer an explanation to the individual or company's question. The letters offer details that enhance the understanding of regulations and how they apply to specific situations.

The dashboard 10 includes a banner 14 that has first, second, and third drop downs 22, 24, 26 that can be used to search and limit the interpretation letters to desired parameters. The first drop down 22 lists various companies that are named in the interpretation letters such as the company requesting the interpretation or a company otherwise listed in the text of the interpretation. The second drop down 24 is allows the interpretation letters to be filtered based upon which particular code of Federal regulations (CFR) is discussed or mentioned in that particular interpretation letter. The third drop down 26 can be selected by the user to filter the displayed interpretation letters based upon which United States Code (USC) is interpreted in the letter or is otherwise mentioned in the interpretation letter. The company types 38 are located on the dashboard 10 along with the value number of how many times that company type appears in the interpretation letters under the current selection. One or more of the company types 38 could be selected in order to limit the displayed interpretation letters to only those that are relevant to those types. The search refinement 20 is also present on the dashboard 10 and can be used to limit the displayed interpretation letters to only those that include the input text into the search refinement 20.

The chart display 36 in FIG. 6 is based upon a search query that does not have any selections made, as indicated in the current search selection window 16. The chart display 36 does not include any graphics and does not have the timeline slide bar 34. The graphical display 30 and the secondary display 62 are both missing. Instead, the chart display 36 has one row for each interpretation letter and a number of columns that provide information on each one of the interpretation letters. The first column lists the date of the letter, and the second column provides text of the letter. The third column lists the company that requested the interpretation letter, and a fourth column provides the footnotes from that particular interpretation letter. The fifth column in the chart display 36 is a reference column that lists the FMVSS rule or rules that are implicated in the interpretation. The sixth column is a link to an external website that can be accessed upon clicking to direct the user to a copy of the interpretation letter. The website that could be access via clicking of the link may be nhtsa.gov on which the interpretation letters could be located. The last column in the chart display 36 is labeled as CFR/USC which includes for that particular interpretation letter which CFR and/or USC rules or laws are interpreted or otherwise discussed. A scroll bar is located on the right side of the chart display 36 that can be slid up or down to view data in the chart display 36 that can't be fit all into one view.

Use of the various selection criteria in the drop downs 22, 24, 26, the time selection 28, the company type 38, and the search refinement 20 will limit the interpretation letters in the chart display 36 to be only those that meet the search criteria. Next to the search clear button 18, a back button 40 is present that if actuated causes the dashboard 10 to jump back to the home display which would be that as shown in FIG. 1 with the monthly tab actuated and no search criteria entered. This back button 40 is also present in the FIG. 5 display of the dashboard 10 relating to the articles, and thus the back button 40 is present in those dashboard 10 displays that include the chart display 36 and not the graphical display 30. If the dashboard 10 were displaying the graphical displays 30 such as those shown in FIGS. 1-4, actuation of the search clear button 18 will revert the dashboard 10 to the initial home page of FIG. 1.

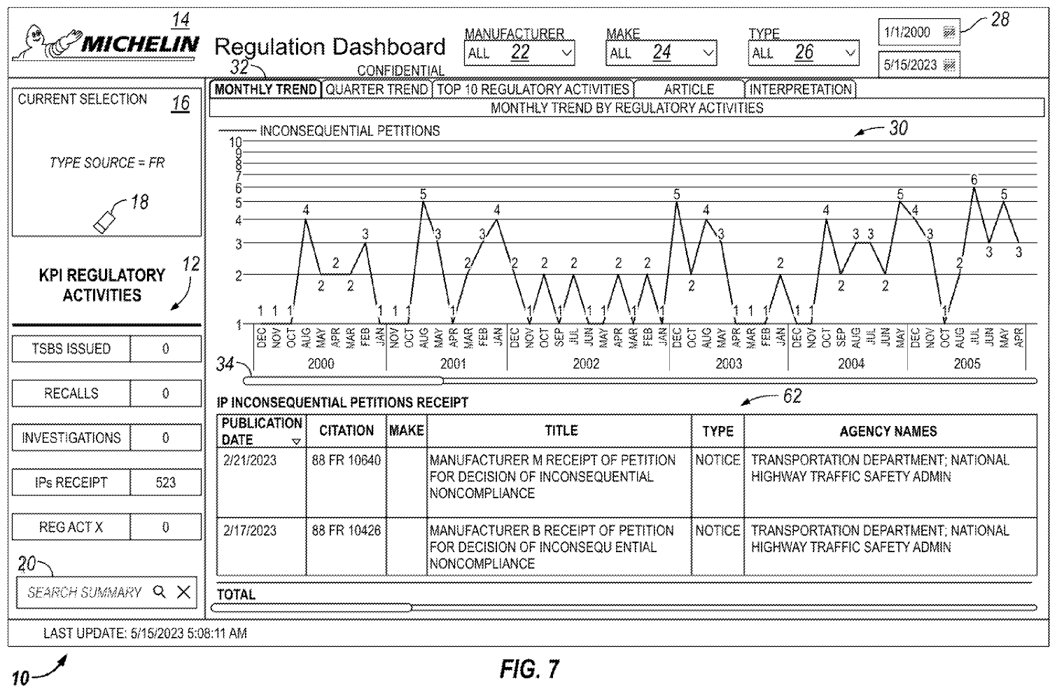

FIG. 7 shows the dashboard 10 as configured according to the inputs in FIG. 1 in which the monthly trend tab 32 is selected and no current search selection window 16 criteria is made with the exception of one difference. Here, the regulatory activities 12 on the left hand side of the dashboard 10 has the IPs Receipt (IP Inconsequential Petitions Receipt) selected by clicking on the bar “Ips Receipt 523.” Selection of this regulatory activity 12 shows in FIG. 7 the rest of the regulatory activities 12 being zeroed out so that they are not considered in the dashboard 10. The graphical display 30 shows data only for the inconsequential petitions and does not show data for any of the other regulatory activities 12. The graphical display 30 is arranged in a similar manner as that previously discussed with the x-axis timeline and the y-axis numerical value, and with the timeline slide bar 34 present to view additional data further in time.

The secondary display 62 is presented differently in the FIG. 7 dashboard 10 display as opposed to those of the secondary displays 62 of FIGS. 1-4 that shows a graphical display. It is to be understood that the secondary display 62 could be a graphical display, or could be a chart in accordance with different exemplary embodiments. The secondary display 62 upon selection of the regulatory activity 12 shows as a chart and lists all of the particular documents that are classified as that regulatory activity 12, which in this instance is the IP Inconsequential Petitions Receipt regulatory activity 12. The chart making up the secondary display 62 includes for each document columns that record its publication date, the citation of the document, the make associated with that IP receipt, the title of the document, the type of the document, and the agency names in that document. The columns of the chart of the secondary display 62 also include the abstract of the document, the document number, a link to an external site that if clicked will open up a new screen on the display and direct the user to the full document. There can be two links provided to the user in the chart, one being a .pdf link that provides a .pdf file of the document, and the other being a html link that directs the user to a website that has the document in this format. A slide bar is present at the bottom of the secondary display 62 that can be slid to the left or right to view information on the documents that cannot be all fully displayed, and a vertical slide bar is present on the right hand side to view additional documents that are not shown due to size constraints.

If a different one of the regulatory activities 12 is selected other than the IP inconsequential petitions receipt, then the secondary display 62 will be presented still in a chart mode, but with some differences. If the TSBS Issued regulatory activity 12 is selected, then the secondary display 62 will show as a chart that has for each one of the TSBSs listed in a row the following columns with the appropriate information: the date the TSBS was added to the dashboard 10, the code failing component, the “make”, the equipment model, the year of the equipment model, the date of the TSBS, and a summary of the TSBS. As such, the chart of the secondary display 62 is modified so that the columns present information appropriate to that particular regulatory activity 12 type.

If the “Recall” regulatory activity 12 is selected, then the secondary display 62 is again displayed as a chart, but with columns that identify the date the report was received, the subject of the report, a description of the recall, the Manufacturer, the Make, the Component subject to the recall, the NHTSA ID number, a link to the full text of the recall, the recall type, whether a park outside advisory is applicable, the number of units that are potentially affected, a summary of the consequences of the problem, the corrective action to be taken, and whether a “do not drive” advisory is or is not in affect. If one were to instead actuate the regulatory activity 12 that are the “investigations” then the secondary display 62 will again display a chart that includes rows of the various investigations with columns that include information about each one of the investigations. The columns headings could include the date the investigation was opened, the equipment “make”, the equipment model, the year of the model, the component description, the manufacturer's name, the NHTSA identification number, the date the investigation was closed, the recall campaign number, the summary description, and the summary detail. If the regulatory activity 12 is an EWR, then the secondary display 62 is again a chart that for each EWR includes a column that provides the quarter the EWR was submitted, the manufacturer, the make, the type of EWR, the report type, the subtype, and number of EWRs for that particular row. Upon actuating any of the regulatory activities 12, the graphical display 30 will always be a graph, and the secondary display 62 will be a chart but with different column headings depending upon the particular regulatory activity 12 actuated.

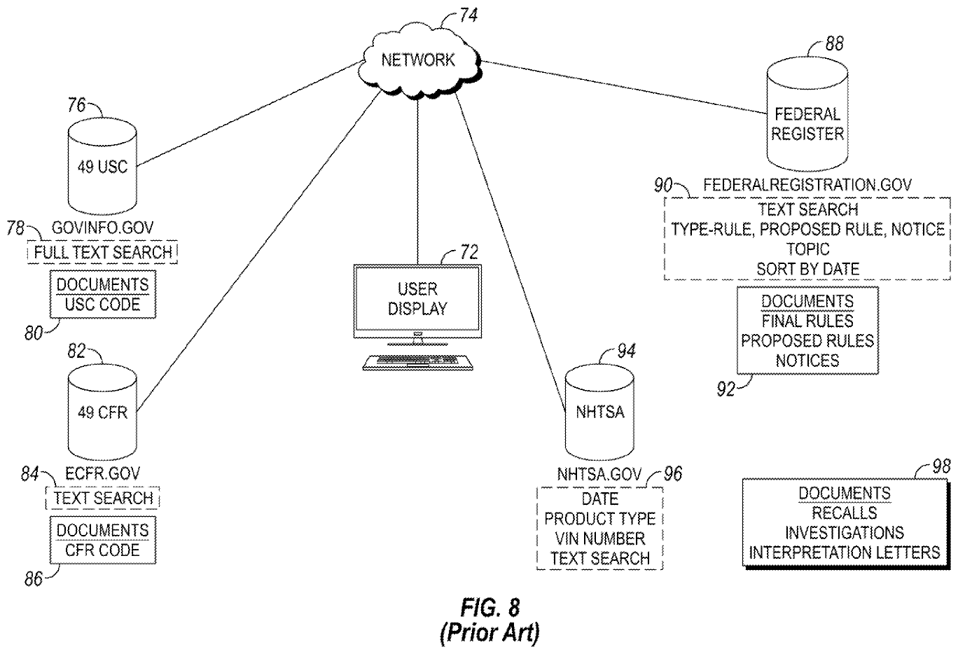

A prior system of searching and accessing automotive regulation system is shown in FIG. 8. Here, the user employs a user interface 72 that can be a lap top computer, cell phone, or any other computing device. The user interface 72 is connected to a network 74 that can be any type of public or private communication network. In some instance, the network 74 is the internet. If the user wants to search and access automotive regulations such as laws that are in USC code, a first database 76 can be accessed as found at web address govinfo.gov. The first database 76 has a first search criteria 78 that is a full text search. Using this full text search, the first search criteria 78 can return first documents 80 that are in this instance various USC code. If the user instead wishes to access CFR code, he or she may access from the user display 72 a second database 82 that is accessed over the network 74 and is separate and remote from the first database 76. The second database 82 has an address of ecfr.gov, and has a second search criteria 84 that is a text search. The second database 82 has a repository of second documents 86 that are CFR code. Using this text search, the appropriate CFR code can be obtained by the user at the second database.

Additional automotive regulations can be accessed from the prior system. A third database 88 has a web address of federalregister.gov and includes a third search criteria 90 that allows the user to execute a text search, a type search (this involves selecting final rule, proposed rule, or notice), a topic search, and a sort by date. Using the third search criteria 90, the third database 88 accesses its third documents 92 which include final rules, proposed rules, and notices and returns those that meet the search criteria. The prior system may also have a fourth database 94 located at nhtsa.gov that includes various documents relevant to the NHTSA. The fourth database 94 has a fourth search criteria 96 that allows documents to be search in the fourth database 94 by data, product type, VIN number, or by text searching. The fourth documents 98 in the fourth database 94 are recalls, investigations, and interpretation letters that can be accessed upon using the desired fourth search criteria 96.

As can be appreciated, to access automotive regulations and laws, the user must use the user display 72 and navigate to various websites to reach the various databases 76, 82, 88, 94. Each one of these databases 76, 82, 88 94 requires the user to read and understand how the desired information is organized and has their own specific search criteria 78, 84, 90, 96 that has to be understood and correctly utilized. The documents that are desired may not be in the database 76, 82, 88, 94 that is accessed, and the search functionality may not be sufficient in the variously designed websites to properly locate the desired documents. The prior system also does not have the ability to present data on the automotive regulations such as the values of regulatory activities 12, graphical trends of regulatory activities 12, top ten lists, high levels of data filtering, and accurate search results. As large number of computer inputs must be made to navigate to all of the different automobile regulations to access them on different sites, the processing speed and requirements of such a system are demanding. A dashboard 10 display of all of the various automobile regulations is not possible under the current state of the art.

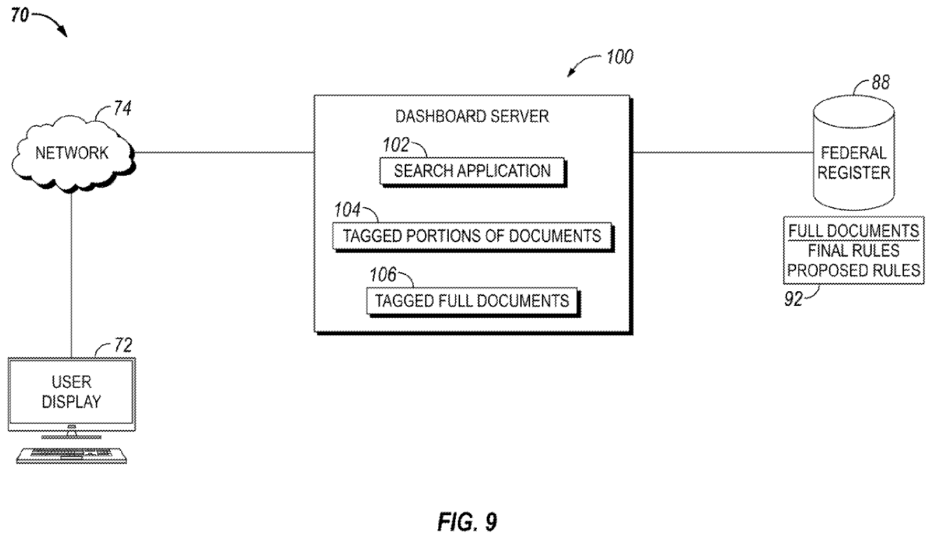

One exemplary embodiment of a system 70 that can display the dashboard 10 and function as discussed previously with respect to FIGS. 1-7 is shown with reference to FIG. 9. A user display 72 is utilized by the user and can be a laptop or other appropriate digital device that can communicate through the network 74 which may be a public or private network such as the internet. Using the user display 72, the user may access the dashboard server 100 through the network 74 which is capable of generating the dashboard 10. The dashboard server 100 has one or more applications, the search application 102 being one of them that can be used to drive the desired searches and search refinements as per the user's needs. Many of the relevant documents concerning the automotive regulations and laws that the user will need are accessible via the dashboard server 100 such that only a single search application 102 can be utilized by the user. In this manner, he or she will not need to go out and access various search criteria 78, 84, 90, 96 but can execute his or her search from a single search application 102. The documents are tagged by the dashboard server 100 so that all of them can be searched by the search application 102. In this regard, the dashboard server 100 can include some entire documents, some abstracts/summaries of documents, and some links to the document. These tagged full documents 106 include the entire text of the interpretation letters that can be accessed via the interpretation tab 32. Clicking on one of these documents on the dashboard will cause the document to be displayed without need to consult an external database 76, 82, 88, 94 remote from the dashboard server 100.

It may also be the case that the dashboard server 100 does not have the entire text of the document therein. Instead, the dashboard sever 100 may have portions of the document which are tagged thereon. These are identified as the tagged portions of documents 104 and include tags which can be read by the search application 102 so that this document can be returned in the search. These tagged portions of documents 104 can be displayed on the dashboard 10 upon making the appropriate inputs with the search application 102. These documents are not included in full on the dashboard 10 but instead summaries and abstracts of the documents such as recalls, inconsequential petitions, investigations, and TSBS issued are included on the dashboard 10 along with links to the full documents on an external website. For the regulatory activity 12 that is the TSBS regulatory activity, summaries of bulletins are provided but no links to the full TSBS report. However, in other embodiments a full link to the TSBS report could be included in the dashboard 10. For Recalls, a summary is provided along with a link to an online location that includes all NHTSA documents for that recall. For the investigations regulatory activity 12, a summary of the investigation is provided but no link to the full investigation is provided. However, in other embodiments of the system, a link to an external website can be provided that can be followed to obtain the full text of the investigation. For the IP receipt, a summary is provided along with a link to the Federal Register at which the full inconsequential petition report can be viewed, and the docket number is provided but no external link. If the regulatory activity 12 is an EWR, statistics are provided with no detail and no link. For articles, abstracts are provided with a link to the Federal Register to view the article, and a docket number is provided but with no link. All of this may be changed in other embodiments in which links or the full document could be present in the dashboard 10 or located on the dashboard server 100.

Should the user desire the entire document be retrieved and viewed, the dashboard server 100 may communicate with the external database 76, 82, 88, 94 through the network 74 without having to get any extra input from the user via the user display 72. In the disclosed embodiment, the CFR code and USC code are tagged to allow them to be displayed in the search results as returned by the dashboard, but the full text of the CFR code, USC code, and any other laws are not provided by the dashboard 10. There may be no link to the CFR code, USC code or other laws provided by the dashboard 10. In other embodiments, the dashboard 10 may provide links to the CFR code, USC code or other laws so that the user can navigate to that site and read their full text. However, the CFR code, USC code or other laws are tagged to allow the search application to know whether or not to return their identification in a search selected by the user. In the FIG. 9 embodiment, the dashboard server 100 communicates with the third database 88 to retrieve one of the third documents 92 which in this instance can be a final rule. Alternatively, the dashboard server 100 can provide a link on the dashboard 10 that if clicked by the user on the dashboard 10 causes a separate window to be opened on the user interface 72 apart from the window in which the dashboard 10 is located and the user display 72 communicates over the network 74 directly to the third database 88 which pulls up the full third document 92 such as the final rule. This technique still reduces processing time and improves the speed because the user does not have to input anything into the third search criteria 90 to access this full third document 92. Instead, the external link on the dashboard 10 has the required web routing built in to automatically cause the full third document 92 to be displayed. It is to be understood that the system 70 as outlined in FIG. 9 is only exemplary and that others are possible. For example, the dashboard server 100 is shown as linking only to the third database 88 that includes the Federal Register. The dashboard server 100 could additionally or alternatively link to one or more additional databases 76, 82, 94 that could include, for example, the NHTSA database.

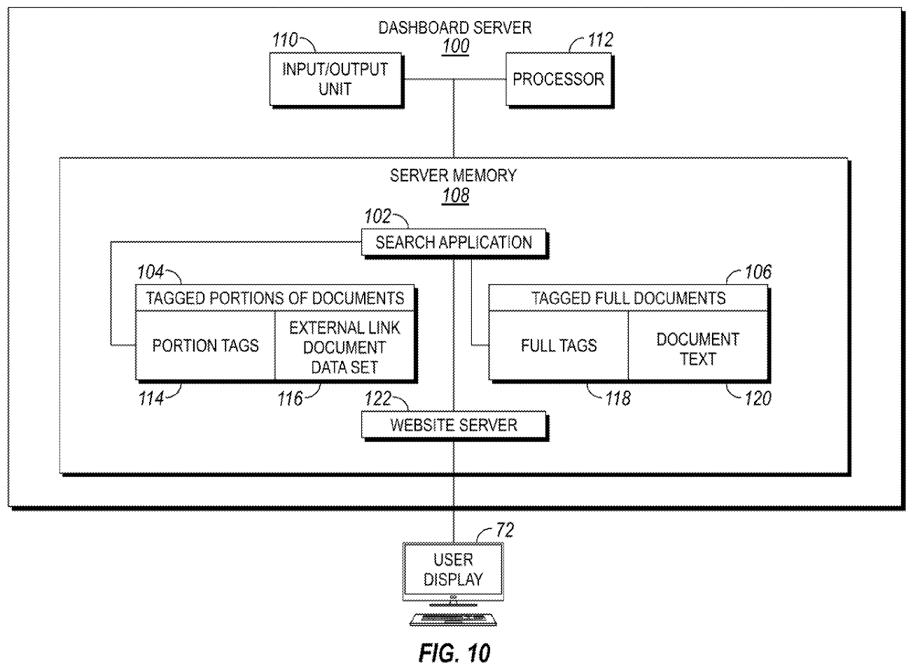

FIG. 10 is a more detailed schematic view of the dashboard server 100 of FIG. 9. The dashboard server 100 includes a server memory 108 that is in communication with a processor 112 and an input/output unit 110 that are likewise in communication with one another. The input/output unit 110 includes basic routines that help to transfer information within the dashboard server 100. The server memory 108 includes a search application 102 that is responsible for obtaining the requested documents for the dashboard server 100. In order to do this, the various documents are tagged as per the various searching criteria. As an example, a particular document could be tagged as an inconsequential noncompliance report document type regulatory activity 22, a Jun. 17, 2022 date, a Make B, an auto manufacturer type, and Manufacturer B as the manufacturer. Other tags can be applied to this document as desired to all of the documents in the database. The search application 102 may query the portion tags 114 and the full tags 118 to return all of the tags that are desired.

The server memory 108 has a tagged portions of documents 104 software module that is a data set of only parts of the document that are set with tags. In this regard, the entire document is not present within the server memory 108, but the relevant portion tags 114 are in fact present within the tagged portions of documents 104. This being the case, the search application 102 can call up the portion tags 114 to identify which documents have the desired tags. This information can be returned by the search application 102 to the website server 122 to indicate to the website server 122 what information to display to the user. Since the actual document may be desired to be viewed by the user, the tagged portions of documents 104 includes an external link document data set 116 that includes a link to an external site that if followed opens up the document in question. The external link document data set 116 can be captured by the search application 102 and then sent to the website server 122 for being viewed by the user and is actionable such that if clicked in the dashboard 10 a separate window is opened on the display and the desired document in the external database 76, 82, 88, 94 is opened. The tagged portions of documents 104 may be abstracts or summaries of the documents.

The server memory 108 also has a tagged full documents 106 software module that is also searchable by the search application 102. The tagged full documents 106 has the document text 120 that is the entire text of the document (in some embodiments the interpretation letters), and each one of these entire texts is tagged with the full tags 118. The search application 102 may query the full tags 118 and if the desire search criteria is discovered in any of the full tags 118, then the search application 102 will return these tags to the website server 122 along with any of the relevant full document text 120 as per the particular dashboard 10 display.

The website server 122 operates to generate and present the dashboard 10 on the user interface 72. The search query made by the user on the user interface 72 will be transferred to the website server 122 which will in turn cause the search application 102 to return the correct search results due to the tags in the portion tags 114 and full tags 118. The website server 122 is provisioned with software instructions that display the correct dashboard 10 display to the user at the user interface 72 and the correct content will be returned by the search application 102. The website server 122 can be a software application in the server memory 108 and need not be a separate server or computer from the server memory 108 or outside of the dashboard server 100. In other embodiments, however, the website server 122 is not a software application and may be a separate computer or server that receives search results and transmits them to the user interface 72. As such, the website server 122 may be a computer component or software or otherwise variously configured.

The system 70 converts very inconvenient and inconsistent formats into a form that is user friendly with search and sort features designed for the needs of manufacturers. The information in the documents is transformed using natural language processing tools. The use of tags on the information classifies the information, and ensures the filtered content is pertinent for the user of the dashboard 10. In order to build the system, a software package can be used to visualize the data. Source code can be used to collect the data from the various databases 76, 82, 88, 94 and transform this data into usable formats by the system 70 for display on the dashboard 10. Comprehensive cross-references are built to categorize the data from these databases 76, 82, 88, 94 by FMVSS, US code, CFR, and NHTSA designations. The tagging of information via the different categories as discussed previously with respect to the description of the dashboard 10 views is a unique approach to achieving a tool useful for a manufacturer.

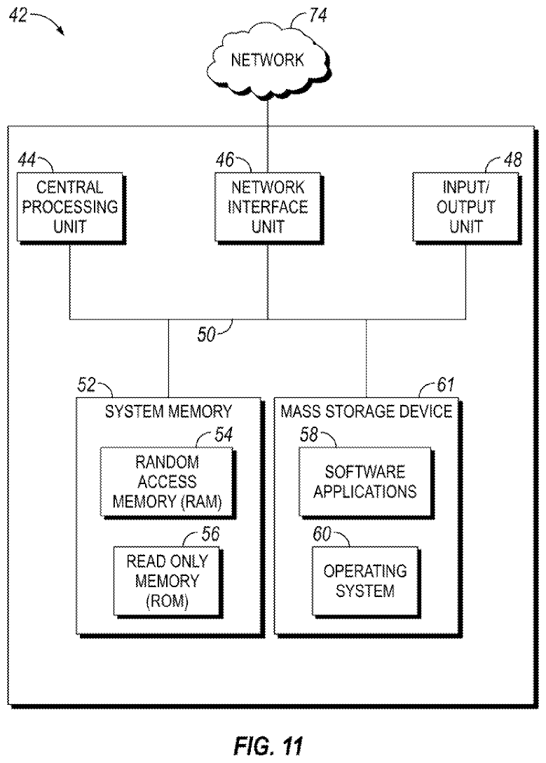

Referring now to FIG. 11, an example block diagram of a computing system 42 is shown that is capable of implementing aspects of the present system. For example, the computing system 42 can be used to implement the user display 72, the dashboard server 100, or any of the databases 76, 82, 88, 94. The computing system 42 includes at least one central processing unit (CPU) 44, a system memory 52, and a system bus 50 that couples the system memory 52 to the central processing unit 44. The system memory 52 includes a random access memory (RAM) 54 and a read only memory (ROM) 56. A basic input/output system that contains the basic routines that help to transfer information between elements within the computing system 42, such as during startup, is stored in the ROM 56. The computing system 42 includes a mass storage device 61 that is able to store software instructions and data. The mass storage device 61 and its associated computer-readable storage media provide non-volatile, non-transitory data storage for the computing system 42. The computer-readable storage media could be a hard disk, a solid state disk, or any tangible physical device from which the CPU 44 can read data.

The computer readable storage media may be volatile or non-volatile, removable or non-removable media implemented in any method for storage of information such as computer readable software instructions. Computer readable storage media may include RAM, ROM, EPROM, EEPROM, flash memory or other types of solid state memory, CD-ROMs, DVDs, cassettes, magnetic tape, magnetic disk or any other medium capable of storing information for the computing system 42.

The computing system 42 may be in a network environment using logical connections to remote network devices through the network 74. The computing system 42 may connect to the network 74 through the network interface unit 46. The computing system 42 includes an input/output unit 48 for receiving and processing input from a number of other devices such as user display screens. The mass storage device 61 and the RAM 54 can store software instructions and data. The software instructions include an operating system 60 suitable for controlling the operation of the computing system 42. The mass storage device 61 has a software application 58 that is executed by the CPU 44 to cause the computing system 42 to provide the functionality of the computing system 42 as discussed herein.

The present invention improves the functioning of a computer. The generation of the dashboard 10 provides greater efficiency to computing devices used to generate and host a website, as well as to computing devices used to access the website. By providing desired automotive regulations in a single location, fewer pages of the website need to be presented to a user in order to obtain the relevant automotive regulations. Fewer websites will need to be accessed in order to obtain the relevant automotive regulations, and a single search can be conducted on one instead of having to do multiple different searches on various websites. A user will, on average, click fewer search items and pages of a website in order to find the relevant automotive regulations. The present system reduces the processing burden of all computing devices involved.

Providing a single dashboard 10 that searches and visualizes the data relating to automotive regulations and can compare different types of regulatory activities provides advantages over existing user interfaces. Previous user interfaces required a user to switch from multiple views of different data and try to piece different types of data together to both obtain all the relevant automotive regulations and to compare the regulatory activity to one another. This requires more time and clicks to interact with data from the websites. The methods, systems, and dashboard 10 of the present disclosure provide improvements with regard to increased flexibility in viewing data, faster data comparisons, and real time data updates. The prior systems required one to use different search databases and use different types of searching from database to database, and did not allow for comparisons of regulatory activity by manufacturer type, make, or to one another. The present system uses searching from a single dashboard 10 that allows for these comparisons, and requires but a single search type be used instead of different searching capability from different websites.

The present system therefore improves computer functionality, and improves how the computer stores and retrieves data by using the dashboard 10 and the tagging system with the data being displayed on the dashboard 10. These features are not conventional and enable a claimed system to achieve benefits over conventional databases, such as increased flexibility, faster search times, and smaller memory requirements. This is because multiple searches on various websites will not have to be performed, and collection and comparison of data is not even possible with existing systems as no automotive regulation system even is capable of comparing regulatory activity. Therefore, the system does not simply involve using general purpose computers to implement an abstract idea, but instead provides a solution to a problem in the software arts.

While the present subject matter has been described in detail with respect to specific embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be apparent.

What is claimed is:

1. A system for searching highway transportation information, comprising:
a user interface;
a dashboard server comprising:
a search application configured for searching a plurality of tagged portions of documents;
a website server configured to generate a dashboard for viewing at the user interface, wherein the website server is configured for receiving communication from the search application and returning searched tagged portions of documents to the user interface;
wherein a first one of the tagged portions of documents is a recall that is searched by the search application and communicated to the website server and returned to the user interface;
wherein a second one of the tagged portions of documents is a final rule that is searched by the search application and communicated to the website server and returned to the user interface.

2. The system as set forth in claim 1, wherein the dashboard server has a server memory that has the search application and the website server, wherein the plurality of tagged portions of documents are located on the server memory.

3. The system as set forth in claim 1, wherein the plurality of tagged portions of documents has portion tags that identify the plurality of tagged portions of documents and are searched by the search application and communicated to the website server and sent to the user interface for display;
wherein the plurality of tagged portions of documents has an external link document data set that has links to external databases that is obtained by the search application and sent to the website server and displayed on the user interface, wherein if actuated at the user interface the links to external databases causes full documents from the external databases to be displayed at the user interface.

4. The system as set forth in claim 1, wherein the search application is configured for searching a plurality of tagged full documents;
wherein the website server is configured for receiving communication from the search application is a first one of the tagged full document and returning the first one of the tagged full document to the user interface.

5. The system as set forth in claim 1, wherein the plurality of tagged portions of documents comprising regulatory activities comprising:
technical service bulletins (TSBSs);
investigations;
inconsequential Petitions (IPs) Receipts; and
complaints.

6. The system as set forth in claim 5, wherein the plurality of tagged portions of documents comprising regulatory activities comprising early warning reports (EWRs).

7. The system as set forth in claim 1, wherein the plurality of tagged portions of documents comprising investigations.

8. The system as set forth in claim 1, wherein the dashboard has a first drop down, a second drop down, and a third drop down that are selectable in order to refine regulatory activities to a current selection such that the numbers of different types of regulatory activities are displayed by the dashboard;
wherein the dashboard has a graphical display that displays the numbers of different types of regulatory activities in graphical form in a selectable time range.

9. The system as set forth in claim 8, wherein the dashboard has a secondary display that displays different bar charts by manufacturer type of the numbers of different types of regulatory activities for that manufacturer type.

10. The system as set forth in claim 8, wherein the dashboard has tabs that allow selection between regulatory activities, articles, and interpretations;
wherein when the tabs are used to select articles the graphical display is removed and instead a chart display is shown in the dashboard that has a listing of National Highway Traffic Safety Administration (NHTSA) articles, wherein the second one of the tagged portions of documents that is the final rule is displayed in the chart display; and
wherein when the tabs are used to select interpretations the graphical display is removed and instead a chart display is shown in the dashboard that has a listing of interpretation letters
wherein the first drop down, the second drop down, and the third drop down are selectable in order to refine the articles and interpretation letters to current selections that are displayed in the chart displays.

11. A system for searching highway transportation information, comprising:
a user interface;
a dashboard server comprising:
a search application configured for searching a plurality of tagged full documents;
a website server configured to generate a dashboard for viewing at the user interface, wherein the website server is configured for receiving communication from the search application and returning searched tagged full documents to the user interface;
wherein a first one of the tagged full documents is a recall that is searched by the search application and communicated to the website server and returned to the user interface;
wherein a second one of the tagged full documents is a final rule that is searched by the search application and communicated to the website server and returned to the user interface.
